(19) United States
(12) Patent Application Publication
(10) Pub. No.: US 2025/0075075 A1
(43) Pub. Date: Mar. 6, 2025

(54) COMPOSITION AND METHOD OF MANUFACTURING BIO-PLASTIC OBJECTS

(71) Applicant: Caroline Zimbalist, Long Island City, NY (US)

(72) Inventor: Caroline Zimbalist, Long Island City, NY (US)

(21) Appl. No.: 18/242,038

(22) Filed: Sep. 5, 2023

(51) Int. Cl. C08L 89/06; C08H 1/06

(52) U.S. Cl. CPC C08L 89/06; C08H 1/06

(57) ABSTRACT

The present invention discloses a novel composition of a bio-plastic mixture and a method for manufacturing bio-plastic objects using said composition. The resulting mixture can be used to create a wide range of flexible and moldable objects, including but not limited to textiles, garments, combs, eyewear, vases, vessels, buttons, and various accessories. The composition comprises water, gelatin, agar, essential oils, and anti-mold paint additive. Further, the inclusion of vegetable glycerin enhances flexibility in forming end-flexible objects. The composition's unique blend of ingredients and the inventive manufacturing process provides creative potential, merging sustainable materials with inventive fabrication techniques across industries such as fashion, art, and design.

### BACKGROUND OF THE INVENTION

### A. Technical Field

The present invention pertains to the field of materials science and manufacturing processes. More specifically, the invention relates to a novel composition of a bio-plastic mixture and a method for manufacturing bio-plastic objects using said composition. The resulting mixture can be used to create a wide range of flexible and moldable objects, including but not limited to textiles, garments, combs, eyewear, vases, vessels, buttons, and various accessories.

### B. Description of Related Art

The field of bio-plastics has witnessed advancements in the creation of environmentally friendly alternatives to conventional plastics. Some of the known prior arts, US20210308914 A1 of Yi Hsuan Sung, discloses about a method of fabricating an all-natural, edible, and vegan artificial flower by using the sculpting method, wherein the artificial botanicals are environmentally friendly and perhaps in different colors and shapes, and designs, producing artificial bouquets for weddings, displays, and desserts. The method involves producing an agar-based mixture by mixing agar, glycerin, and water to boil, casting the boiled agar-based mixture in a flower-shaped mold cavity, solidifying, hardening, further generating a colored agar-based mixture by adding a colorant that includes mica powder, pigment, dye, and oil-based or water-based paints. The obtained mixture is heated and stirred/mixed to a boiling temperature, where the heated agar-based mixture is loaded or poured into a squeeze bottle, and pour the boiled/boiling agar-based mixture into a three-dimensional (3D) mold cavity, where the mold cavity is machined, or fabricated and shaped as desired. Further, the agar-based mixture may stick or adhere to the cavity mold during hardening, where the mold sticking or adherence inhibited the material shrinkage that produces prototype, agar-based sheets, yarns, and ropes. The agar-based mixture is a moldable, biodegradable, natural, and renewable bio-plastic material, and is used to home decorating articles, and fashion and clothing accessories, such as jewelry, etc.

Another known prior art, US20230173799 A1 of Stefano Bartolucci, discloses about a biodegradable and/or home-compostable sachet. The sachet includes a front film comprising a front and a back middle layer with a material containing cellulose, cellulose acetate, metalized cellulose, metalized cellulose acetate, and its combinations. A sheet-forming step involves extrusion, casting, molding, vacuum-forming, pressing, printing, coating, etc. The sachet product is a consumer product selected from laundry detergent products, fabric softening products, hand cleansing products, moisturizing products, etc. A biodegradable laminate comprises ink and/or dye to provide a background color to the packages. The solid article is lightweight, as compared to a similar dose of traditional liquid products that generally contain at least 80% water, and can be stored in sachet packaging, wherein the sachet packaging is commonly used to store small amounts of consumer products.

Yet another known prior art, U.S. Pat. No. 7,332,214 B2 of Akio Ozasa, discloses about a method of biodegradable expanded disposable molded articles that are molded in a specified shape. The molded method involves molding a biodegradable expanded molded article and attaching a coating film, heating a slurry or dough molding material and the coating film in a mold by steam-expanding the biodegradable expanded molded article into a specific shape, and compress-bonding the coating film through heating and softening the film. The continuous boiling test was conducted by pouring 400 cm³ of boiling water into each biodegradable molded article by putting an electric heater into the boiling water and assessing the condition of the coating film and the shape of the biodegradable molded article. A coloring agent is an additive to color the whole expanded molded article. The method involves press-molding a sheet that is made of polysaccharide or protein that is formed in a metal mold.

However, above-mentioned traditional composition and method lacks to disclose a unique agar-based bio composition, specifically that does not need to boil, just slight heating process is enough for making any bio-plastic objects. Further, above-mentioned traditional composition and method lacks to disclose or teach the following: a method for customization of shapes or sculpting biomaterials. The created biomaterial can be dyed with paint or alcohol ink to make functional and decorative sculptures like vases/vessels, garments, eyewear, combs, and buttons. The method is eco-friendly, utilizing bio-degradable and lightweight materials. It requires minimal energy and can mimic traditional fabric draping techniques. Additionally, the technique involves pouring the biomaterial to create fabrics/garments and augmented without the need for any 3D molds.

Therefore, there is a need for a distinctive aspect of the bio-plastic creation process, focusing on their composition, molding techniques, hand-shaping, and individualized coloring. This present invention discloses adaptability and creative potential of bio-plastic materials in crafting a range of functional and artistic items.

### SUMMARY OF THE INVENTION

The present invention discloses a novel bio-plastic composition and a method for manufacturing versatile and flexible bio-plastic objects. The composition comprises water, gelatin, agar, essential oils, anti-mold paint additive, and optionally, acrylic paint and/or alcohol ink. Further, the inclusion of vegetable glycerin enhances flexibility in forming end-flexible objects.

The manufacturing method involves several key steps. First, the bio-plastic mixture, consisting of the disclosed composition, is prepared. The mixture is then heated and stirred to achieve a homogeneous blend. Subsequently, the heated bio-plastic mixture is poured onto non-stick surfaces and allowed to set for 24 hours. After this period, the resulting material is peeled up, revealing a flexible fabric-like substance.

The method offers various routes for object creation using said composition (heated bio-plastic mixture). Objects such as combs, buttons, and accessories are crafted by sculpting the heated bio-plastic mixture, allowing for intricate detailing and customization. Additionally, the fabric can be draped over cylinders or geometric objects, then hardened to form vases or vessels, showcasing its adaptability. The utilization of three-dimensional (3D) molds is another facet of the method, enabling the production of items like combs, eyewear, and buttons with precision and consistency. Moreover, manual shaping, coupled with 3D molds, allows for unique design variations, granting creative freedom.

The present invention extends to the assembly of larger structures. Multiple fabric parts can be combined or joined to create sculptural body suits or various textile and garment patterns. An epoxy coating reinforces these connections, enhancing durability and structural integrity. The bio-plastic objects manufactured through this method encompass a wide range of possibilities, including textile fabrics/garments, combs, eyewear, vases, vessels, buttons, and other known accessories.

Henceforth, the present invention introduces an innovative bio-plastic composition and a method for producing flexible and versatile bio-plastic objects. The composition's unique blend of ingredients and the inventive manufacturing process provides creative potential, merging sustainable materials with inventive fabrication techniques across industries such as fashion, art, and design.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a composition of bio-plastic mixture (rigid mixture), according to an embodiment of the present invention.

FIG. 2 exemplarily illustrates a composition of bio-plastic mixture (flexible mixture), according to an embodiment of the present invention.

FIG. 3 exemplarily illustrates a flowchart of a method of manufacturing bio-plastic objects, according to an embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

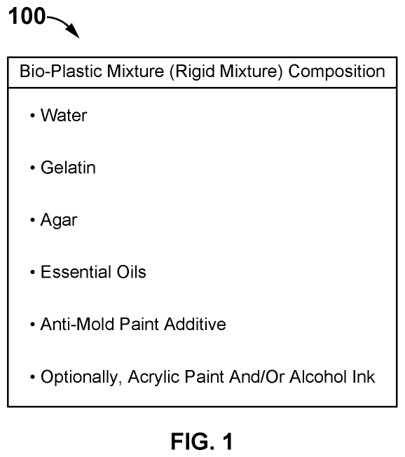

The present invention discloses a composition and a method for manufacturing bio-plastic objects. The resulting composition can be used to create a wide range of flexible and moldable bio-plastic objects, including but not limited to textiles, garments, combs, eyewear, vases, vessels, buttons, and various accessories. Referring to FIG. 1, a composition 100 of bio-plastic mixture (rigid mixture) that enable to form a rigid bio-plastic objects, is illustrated. According to the present invention, the composition 100 of the bio-plastic rigid mixture comprises, water, gelatin, agar, essential oils, anti-mold paint additive, and optionally, acrylic paint and/or alcohol ink.

Further, the percentage of the composition 100 may vary according to the end-product characteristics/requirement. For example, to prepare this composition 100 at household or in small-scale, the composition 100 of the bio-plastic rigid mixture includes: 1 (˜8 fluid ounces/about 237-250 mL) cup water, ½ (˜4 fluid ounces/about 115-130 mL) cup gelatin, 1 teaspoon (˜4 gms) agar, ½ teaspoon (˜2 gms) essential oil, ½ teaspoon (˜2 gms) anti mold defense paint additive, and acrylic paint and/or alcohol ink added at discretion.

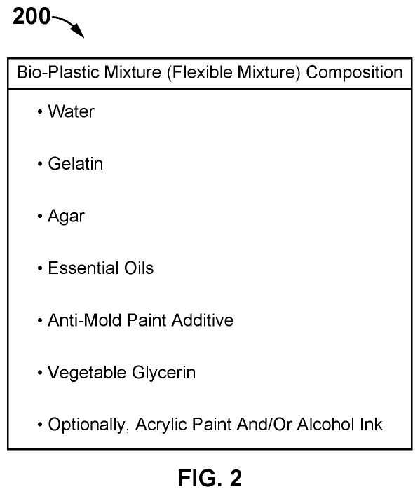

FIG. 2 exemplarily illustrates a composition 200 of bio-plastic mixture (flexible mixture) to enable flexibility in an end-flexible bio-plastic object, according to an embodiment of the present invention. According to the present invention, the composition 200 of the bio-plastic rigid mixture comprises, water, gelatin, agar, essential oils, anti-mold paint additive, vegetable glycerin, and optionally, acrylic paint and/or alcohol ink. Further, the percentage of the composition 200 may vary according to the end-product characteristics/requirement. For example, to prepare this composition 200 at household or in small-scale, the composition 200 of the bio-plastic rigid mixture includes: 1 cup (˜8 fluid ounces/about 237-250 mL) water, ½ cup (˜4 fluid ounces/about 115-130 mL) gelatin, 1 teaspoon (˜4 gms) agar, ½ teaspoon (˜2 gms) essential oil, ½ teaspoon (˜2 gms) anti mold defense paint additive, ½ cup (˜4 fluid ounces/about 115-130 mL) vegetable glycerin (for flexibility), and acrylic paint and/or alcohol ink added at discretion.

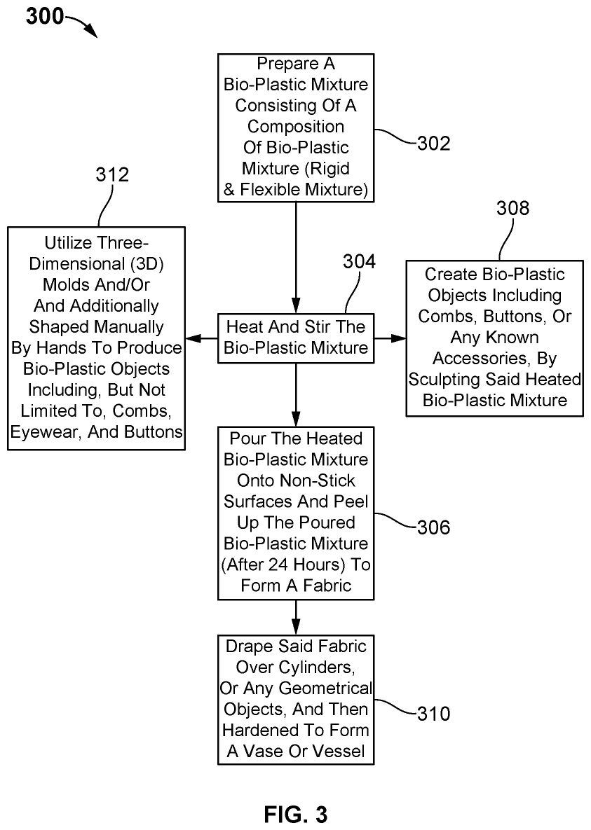

Referring to FIG. 3, a flowchart of a method 300 of manufacturing bio-plastic objects, is illustrated. At step 302, a bio-plastic mixture is prepared that consists of bio-plastic mixture (rigid mixture) and bio-plastic mixture (flexible mixture), as illustrated in FIGS. 1 and 2. Then, at step 304, the bio-plastic mixture is heated and stirred simultaneously using a heater cum blender machine, at slightly lower temperature than boiling temperature. Henceforth, this process consumes less energy, comparing to other known prior arts. At step 306, the heated bio-plastic mixture poured onto a non-stick surface, and dried for approximately 24 hours. Then, the poured dried bio-plastic mixture could be peeled up to form a fabric. In some embodiments, one or more parts or pieces of the fabric are combined or joined together to form a sculptural body suit or any textile or garment pattern.

According to the present invention, the method 300 further comprises the step 308 of, creating one or more objects including combs, buttons, or any known accessories, by sculpting said heated bio-plastic mixture (i.e., heated bio-plastic mixture at step 304). The method 300 further comprises the step 310 of, draping said fabric over one or more cylinders, or any geometrical objects, and then hardened to form a vase or vessel. In some embodiments, the method 300 may utilize three-dimensional (3D) molds to produce one or more bio-plastic objects including, but not limited to, combs, eyewear, and buttons, at step 312. In another embodiment, the method 300 may utilize three-dimensional (3D) molds and additionally shaped manually by hands to produce one or more bio-plastic objects including, but not limited to, combs, eyewear, and buttons, at step 312.

In various embodiments, the bio-plastic objects are any two-dimensional (2D) or three-dimensional (3D) objects, but not limited to, a textile fabrics/garment, comb, eyewear, vase or vessel, and button or any known accessories.

An exemplary method of making a bio-plastic object at household or in small-scale is described herein, as follows. The process for creating bio-plastic pieces involves combining gelatin, agar, glycerin, essential oils, and mold-resistant coating. After gentle heating, the mixture is poured into cups, where colors can be added. The colored liquid is poured onto non-stick surfaces, allowing colors to blend. Once dry, the material can be treated like fabric-shaped into objects, draped over forms to harden, or manually shaped into ornaments or clothing. The technique enables customization and is used in combination with conventional fabrics for crafting costumes. Notably, the method relies on manual shaping and does not heavily employ 3D molds.

In addition, the present invention involves specific recipes for combs, eyewear, and buttons, utilizing a similar base mixture as described earlier. Notably, the mixture is poured into 3D molds, but what sets this present invention apart from known prior arts, is that each piece is also shaped by hand before being finalized. Additionally, each piece is individually colored using acrylic paint and/or alcohol ink, ensuring uniqueness in both shape and color. The composition, optionally, dyed with acrylic paint to create functional and decorative sculptures such as, but not limited to, vases, lighting sculptures, wearable garments, buttons, and other objects.

Advantageously, the composition of the bio-plastic mixture is distinctive, involving ingredients like gelatin, agar, glycerin, essential oils, and a mold-resistant coating. This unique combination sets it apart from other known prior art mixtures. Unlike traditional methods, there is a need for a technique that doesn't require the mixture to be boiled (instead, it is slightly heated), which is a departure from common approaches. While certain objects like combs, eyewear, and buttons are poured into 3D molds, a significant differentiator is that these items are also manually shaped before final drying. Hand-shaping ensures individual uniqueness, and departs from the standard practice of relying solely on molds.

The innovative method involves pouring the mixture onto diverse non-stick surfaces, and creating imprints that distinguish the material's texture. The material is used similarly to woven fabric, allowing it to be draped, shaped, and molded into wearable garments, accessories, and other objects, echoing the flexibility of textiles. By draping the material over cylinders and objects, it hardens into forms like vases and vessels. This technique combines mold-less forming with the advantage of rigid shapes. The process includes augmenting some produced items with epoxy or a certain coating, adding an extra layer of invention to the final products. The use of bio-plastic fabric is more environmentally friendly compared to traditional textiles. The mixture is lightweight, biodegradable, and requires minimal energy to produce. The gelatin-based bioplastic can achieve traditional fabric draping techniques like pleats, tucks, gathers, and ruching, further expanding its range of applications.

Preferred embodiments of this invention are described herein, including the best mode known to the innovators for carrying out the invention. It should be understood that the illustrated embodiments are exemplary only and should not be taken as limiting the scope of the invention.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A composition of bio-plastic mixture, comprising:
(a) Water;
(b) Gelatin;
(c) Agar;
(d) Essential oils, and
(e) Anti-mold paint additive.

2. The composition of claim 1, further comprises vegetable glycerin to form a flexible bio-plastic object.

3. The composition of claim 1, further comprises optionally, acrylic paint and/or alcohol ink to provide required color to a bio-plastic object.

4. A method of manufacturing one or more rigid bio-plastic objects, comprising the step of:
(a) preparing a bio-plastic mixture consisting of a composition including: water, gelatin, agar, essential oils, anti-mold paint additive, and optionally, acrylic paint and/or alcohol ink;
(b) heating and stirring the bio-plastic mixture, and
(c) pouring the heated bio-plastic mixture onto one or more non-stick surfaces and peeling up the poured bio-plastic mixture (after 24 hours) to form a fabric.

5. The method of claim 4, further comprising the step of: creating one or more objects including combs, buttons and any known accessories by sculpting said heated bio-plastic mixture.

6. The method of claim 4, further comprising the step of: draping said fabric over one or more cylinders and any known geometrical object, and hardened to form a vase or vessel.

7. The method of claim 4, further uses one or more three-dimensional (3D) molds to produce one or more bio-plastic objects including combs, eyewear, and buttons.

8. The method of claim 7, further uses the three-dimensional (3D) molds and additionally, shaped manually by hands to produce one or more bio-plastic objects including combs, eyewear, and buttons.

9. The method of claim 4, wherein one or more parts or pieces of the fabric are combined or joined together to form a sculptural body suit or any textile or garment pattern.

10. The method of claim 9, wherein one or more parts or pieces of the fabric are combined or joined together using an epoxy coating to form a sculptural body suit or any textile or garment pattern.

11. The method of claim 4, wherein one or more bio-plastic objects are any one of a textile fabrics/garment, comb, eyewear, vase or vessel, and button or any known accessories.

12. A method of manufacturing one or more flexible bio-plastic objects, comprising the step of:
(a) preparing a bio-plastic mixture consisting of a composition including: water, gelatin, agar, essential oils, anti-mold paint additive, vegetable glycerin and optionally, acrylic paint and/or alcohol ink;
(b) heating and stirring the bio-plastic mixture, and
(c) pouring the heated bio-plastic mixture onto one or more non-stick surfaces and peeling up the poured bio-plastic mixture (after 24 hours) to form a fabric.

13. The method of claim 12, further comprising the step of: creating one or more objects including combs, buttons and any known accessories by sculpting said heated bio-plastic mixture.

14. The method of claim 12, further comprising the step of: draping said fabric over one or more cylinders and any known geometrical object, and hardened to form a vase or vessel.

15. The method of claim 12, further uses one or more three-dimensional (3D) molds to produce one or more bio-plastic objects including combs, eyewear, and buttons.

16. The method of claim 15, further uses the three-dimensional (3D) molds and additionally shaped manually by hands to produce one or more bio-plastic objects including combs, eyewear, and buttons.

17. The method of claim 12, wherein one or more parts or pieces of the fabric are combined or joined together to form a sculptural body suit or any textile or garment pattern.

18. The method of claim 17, wherein one or more parts or pieces of the fabric are combined or joined together using an epoxy coating to form a sculptural body suit or any textile or garment pattern.

19. The method of claim 12, wherein one or more bio-plastic objects are any one of a textile fabrics/garment, comb, eyewear, vase or vessel, and button or any known accessories.
